(19) United States
(12) Patent Application Publication
(10) Pub. No.: US 2015/0362241 A1
(43) Pub. Date: Dec. 17, 2015

(54) DRIVING DEVICE OF ICEMAKER FOR REFRIGERATOR

(71) Applicant: SCD CO., LTD., Gyeonggi-do (KR)

(72) Inventor: Jin Ho LEE, Gyeonggi-do (KR)

(73) Assignee: SCD CO., LTD., Gyeonggi-do (KR)

(21) Appl. No.: 14/379,860

(22) PCT Filed: Mar. 7, 2013
(86) PCT No.: PCT/KR2013/001836

§ 371 Date: Aug. 20, 2014

(30) Foreign Application Priority Data
Mar. 9, 2012 (KR) 10-2012-0024417

(51) Int. Cl. F25C 1/00; F16H 1/20

(52) U.S. Cl. CPC F25C 1/00; F16H 1/20

(57) ABSTRACT

A driving device of an icemaker for refrigerator may include: a case 100; a driving unit 110 mounted in the case 100, including a gear unit 104 having a magnet M formed thereon and a motor M connected to the gear unit 104, and configured to drive an icemaker of a refrigerator; and a housing 100b into which the case 100 including the driving unit 110 is detachably inserted. Since the driving device of the icemaker is assembled as a module, the assembly time and speed may be improved to increase workability. Simultaneously, a low-voltage DC step motor may be used to reduce a risk of fire and electric shock, thereby increasing stability. Furthermore, since the magnet M is rotated around the center axis of the gear unit, a rotation signal may be sensed and outputted through a constant magnetic force. Thus, the merchantable quality of the driving device may be maximized.

### TECHNICAL FIELD

The present invention relates to a driving device of an icemaker for refrigerator, and more particularly, to an apparatus for driving an icemaker for refrigerator, which can transmit and control power for pushing ice to an icebox in a refrigerator and can be easily assembled.

### BACKGROUND

In general, an icemaker includes a tray device for freezing water and a driving device for automatically separating ice.

At this time, the driving device operates an ice detection arm for detecting the amount of ice within an ice container, using a motor. The ice detection arm detects the amount of ice while driven by a cam surface or the like which is formed on a cam gear.

The cam gear of the driving device is configured to have at least three positions. The three positions may include an ice making position at which the ice detection arm is set in a waiting state and an operation of making ice is performed, an ice detection position at which the ice detection arm detects whether the ice container is full of ice, and an ice separation position at which ice within an ice making tray is separated from the ice making tray when the amount of ice within the ice container is insufficient.

That is, the driving device vertically moves the detection arm through rotations of the cam gear such that the detection arm detects the amount of ice within the ice container.

Furthermore, in order to check the position of the ice detection arm during the detection operation, a detection signal is generated at each of the ice making position, the ice-full position, and the ice separation position. According to the detection signal, the motor for driving the ice detection arm is turned on/off or the rotation direction thereof is controlled.

However, since the conventional driving device has a complex structure, it is difficult to assemble the driving device and it takes a lot of time to assemble the driving device. Furthermore, the complex structure of the driving device may increase the defect occurrence rate.

### DISCLOSURE

### Technical Problem

The present invention has been made in an effort to solve the above mentioned problem by providing an apparatus for driving an icemaker for refrigerator, which can transmit and control power for pushing ice to an icebox in a refrigerator and can be easily assembled.

### Technical Solution

In accordance with an embodiment of the present invention, a driving device of an icemaker for refrigerator may include: a case; a driving unit mounted in the case, including a gear unit having a magnet formed thereon and a motor connected to the gear unit, and configured to drive an icemaker of a refrigerator; and a housing into which a case including the driving unit is detachably inserted.

The driving unit may include a hall IC, and the hall IC may be interconnected with the gear unit.

The motor may include a DC step motor.

In addition, a rotating gear may be provided at the end of the rotating shaft of the motor.

The gear unit may include: a first gear engaged with a rotating shaft of the motor; a second gear engaged with the first gear; a third gear engaged with the second gear; and a fourth gear engaged with the third gear and positioned on the bottom surface of the case so as to transmit a rotational force of the motor to a shaft of the icemaker.

The magnet may be mounted on the first gear, and sense and output a signal generated through rotation of the gear unit in interconnection with the hall IC of the driving unit.

The magnet mounted on the first gear and a receiving surface of the hall IC may be provided to face each other in a state where the magnet and the receiving surface of the hall IC are separated at a predetermined interval from each other, and the magnet may transmit a constant magnetic field signal, generated while the magnet is rotated around the rotating shaft of the first gear, to the hall IC.

### Advantageous Effects

According to the embodiment of the present invention, since the driving device of the icemaker is assembled as one module, the assembly time and speed may be improved to increase workability. Simultaneously, the low-voltage dc motor may be used to reduce the risk of fire and electric shock, thereby increasing stability. Furthermore, since the magnet is rotated around the center axis of the gear unit, a rotation signal may be sensed and outputted through a constant magnetic force. Thus, the merchantable quality of the driving device may be maximized.

### BRIEF DESCRIPTION OF THE DRAWINGS

FIG. 1 is an exploded perspective view of a driving device of an icemaker for refrigerator according to the embodiment of the present invention.

FIG. 2 is a diagram illustrating the driving device of the icemaker for refrigerator according to the embodiment of the present invention.

FIG. 3 is a diagram illustrating the driving device of the icemaker for refrigerator and a shaft of the icemaker for refrigerator according to the embodiment of the present invention.

FIG. 4 is a diagram illustrating a magnet and a hall IC in the driving device of the icemaker for refrigerator according to the embodiment of the present invention.

FIG. 5 is a plan view illustrating an operation state of the magnet mounted on a gear unit in the driving device of the icemaker for refrigerator according to the embodiment of the present invention.

### BEST MODE FOR THE INVENTION

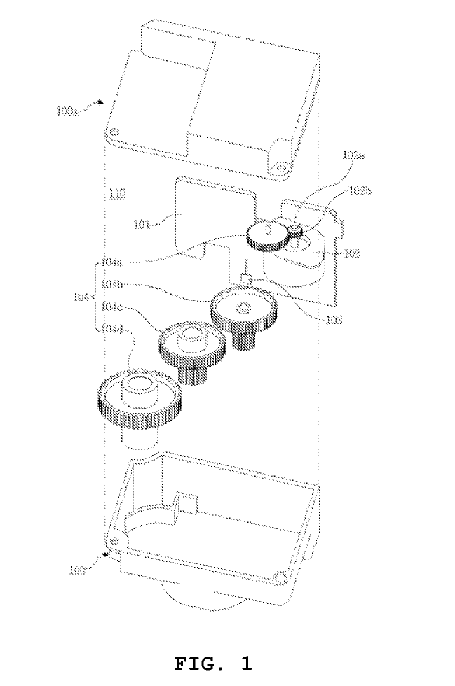

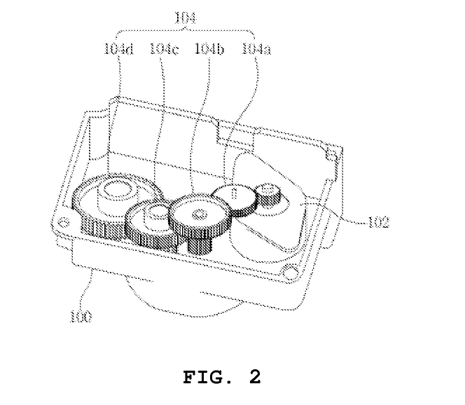

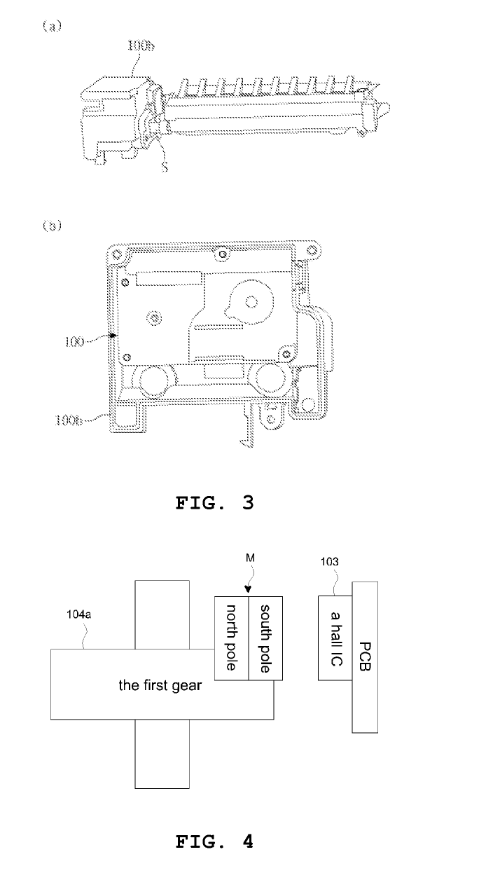

FIGS. 1 to 5 illustrate a driving device of an icemaker for refrigerator according to an embodiment of the present invention. FIG. 1 is an exploded perspective view of the driving device of the icemaker for refrigerator according to the embodiment of the present invention. FIG. 2 is a diagram illustrating the driving device of the icemaker for refrigerator according to the embodiment of the present invention. FIG. 3 is a diagram illustrating the driving device of the icemaker for refrigerator and a shaft of the icemaker for refrigerator according to the embodiment of the present invention.

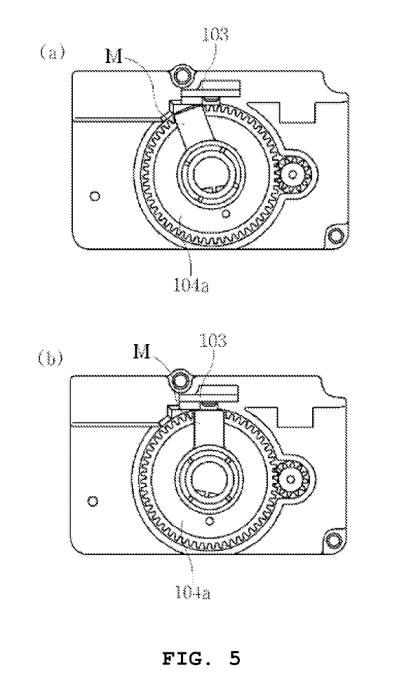

FIG. 4 is a diagram illustrating a magnet and a hall IC in the driving device of the icemaker for refrigerator according to the embodiment of the present invention. FIG. 5 is a plan view illustrating an operation state of the magnet mounted on a gear unit in the driving device of the icemaker for refrigerator according to the embodiment of the present invention.

Exemplary embodiments of the present invention will be described in detail with reference to the accompanying drawings.

As illustrated in FIGS. 1 to 5, the driving device of the icemaker for refrigerator according to the embodiment of the present invention includes a case 100, a driving unit 110, and a housing 100b. The case 100 forms the exterior of the driving device of the icemaker, and has a space formed therein. The driving unit 110 is mounted in the case 100, generates a driving force, and transmits the generated driving force to the icemaker provided outside the case 100. The case 100 including the driving unit 110 is detachably inserted into the housing 100b. The case 100 and the driving unit 110 are integrally assembled to connect various wirings coupled to the icemaker to input/output terminals of the driving unit 110. Thus, the above-described structure may improve the assembly relationship of the driving device.

Hereafter, the components of the driving device of the icemaker for refrigerator according to the embodiment of the present invention will be described one by one with reference to the accompanying drawings.

The driving device of the icemaker for refrigerator according to the embodiment of the present invention has a basic structure in which the driving unit 110 is mounted in the case 100 and the case 100 including the driving unit 110 is detachably inserted into the housing 100b.

As illustrated in FIGS. 1 and 2, the case 100 forms the exterior of the driving unit 110, and a cover 100a is provided at the top of the case 100 such that the case 100 and the cover 100a are coupled to each other. The driving unit 110 to be described below is provided in the internal space of the case 100.

Furthermore, as illustrated in FIG. 3, the driving device of the icemaker for refrigerator according to the embodiment of the present invention may include the housing 100b through which the driving unit 110 is mounted in the refrigerator. The cover 100a and the case 100 including the driving unit 110 may be provided in the housing 100b.

The driving unit 110 includes a circuit board 101 having a plurality of input/output terminals formed thereon, a motor 102 for generating a driving force, a gear unit 104 having a magnet M formed thereon, and a hall IC for detecting a position in interconnection with the gear unit 104 and outputting a high signal (ice-scarce state) or low signal (ice-full state) to indicate whether the amount of ice is large or small. The driving unit 110 drives the icemaker of the refrigerator.

At this time, the motor 102 of the driving unit 110 may be implemented with a low-voltage DC step motor. Then, the driving unit 110 may be stably operated to reduce the risk of fire caused by an electrical shock.

That is, the driving unit 110 rotates the gear unit 104 by a step number set through the step motor, and senses the rotation position of the rotated gear unit 104. Furthermore, the driving unit 110 senses whether the amount of ice within the ice container is large or small, according to the point-to-point connection state between the hall IC 103 and the magnet M interconnected with the gear unit 104.

In another embodiment, the driving unit 110 includes a motor 102 for generating a driving force and a gear unit 104 having a magnet M formed thereon. The motor 102 and the gear unit 104 are mounted on a circuit board 101 including a plurality of input/output terminals, and positioned in the case 100.

Furthermore, as illustrated in FIG. 3, the case 100 including the driving unit 110 may be detachably provided in the housing 100b. That is, the driving unit 110 may be implemented as a module.

At this time, the driving unit 110 may include the hall IC 103, and the hall IC 103 may sense the position of the gear unit 104 in interconnection with the gear unit 104, and output a high signal (ice-scarce state) or low signal (ice-full state) to indicate whether the amount of ice is large or small. According to the state signal, the driving unit 110 may be driven to operate the icemaker for refrigerator according to the embodiment of the present invention.

The motor 102 controls the rotation angle of the gear unit 104 according to the number of pulses given per second.

The gear unit 104 serves to transmit a rotational force generated by the motor 102 to the icemaker, and includes a first gear 104a, a second gear 104b, a third gear 104c, and a fourth gear 104d.

The first gear 104a is engaged with a rotating shaft 102a of the motor 102. The rotating shaft 102a may have a rotating gear 102b formed on the outer circumferential surface thereof so as to be engaged with the first gear 104a.

The second gear 104b is rotated in a state where the second gear 104b is engaged with the first gear 104a. The second gear 104b has a two-stage structure including a top gear and a bottom gear, of which the outer circumferential surfaces have different sizes. The top gear is engaged with the first gear 104a, and the bottom gear is engaged with the third gear 104c to be described below.

The third gear 104c is rotated in a state where the third gear 104c is engaged with the second gear 104b. The third gear 104c has a two-stage structure including a top gear and a bottom gear, of which the outer circumferential surfaces have different sizes. The top gear is engaged with the second gear 104b, and the bottom gear is engaged with the fourth gear 104d to be described below.

The fourth gear 104d is rotated in a state where the fourth gear 104d is engaged with the third gear 104c. The fourth gear 104d has a two-stage structure including a top gear and a bottom gear, of which the outer circumferential surfaces have different sizes. The top gear is engaged with the third gear 104c, and the bottom gear is positioned on the bottom surface of the case 100 so as to transmit the rotational force generated from the motor 102 of the driving unit 110 to a shaft S (refer to FIG. 3) of the icemaker.

At this time, the bottom gear of the fourth gear 104d has an insertion hole formed at the center thereof such that the shaft S of the icemaker is inserted into the insertion hole. Thus, the rotational force generated from the motor 102 may be transmitted to the icemaker through the gear unit 104.

Furthermore, as illustrated in FIGS. 4 and 5, the magnet M is mounted on the first gear 104a, and interconnected with the hall IC 103 of the driving unit 110 so as to sense a signal generated through rotation of the gear unit 104 through a magnetic force. Then, the magnet M outputs the sensed signal.

At this time, the magnet M and the hall IC 103 may be provided to face each other in a state where they are separated at a predetermined interval from each other. Thus, a magnetic field signal generated while the magnet M is rotated around the rotating shaft of the first gear 104a may be transmitted to the hall IC 103.

The hall IC 103 is an IC used for detecting a non-contact displacement. In the embodiment of the present invention, while the magnet M is moved perpendicular to the hall IC 103 around the center axis (rotation axis) of the first gear 104a, the magnet M transmits a magnetic field signal to the hall IC 103. Thus, when a signal is sensed, the signal may be stably outputted.

Hereafter, the operation and effect of the driving device of the icemaker for refrigerator according to the embodiment of the present invention will be described as follows.

As illustrated in FIGS. 1 and 2, the driving device of the icemaker for refrigerator according to the embodiment of the present invention includes the case 100 and the driving unit 110. The case 100 forms the exterior of the driving device of the icemaker, and has a space formed therein. The driving unit 110 is mounted in the case 100, generates a driving force, and transmits the generated driving force to the icemaker provided outside the case 100. The case 100 and the driving unit 110 are integrally assembled to connect various wirings coupled to the icemaker to input/output terminals of the driving unit 110. The above-described structure may improve the assembly relationship of the driving device.

The hall IC 103 for sensing whether the amount of ice in the icemaker is large or small recognizes the position of the gear unit 104 in interconnection with the gear unit 104 having the magnet M formed thereon, and outputs a signal indicating whether the icemaker is in an ice-scarce state or ice-full state. Then, according to the output signal, the motor 102 is operated to drive the icemaker of the refrigerator.

That is, the driving unit 110 rotates the gear unit 104 by a step number set through the step motor, and senses the rotation position of the rotated gear unit 104. Furthermore, the driving unit 110 senses whether the amount of ice within the ice container is large or small, according to the point-to-point connection state between the hall IC 103 and the magnet M interconnected with the gear unit 104.

The first gear 104a is engaged with the rotating shaft 102a of the motor 102 so as to transmit a rotational force generated from the motor 102 to the second gear 104b, the second gear 104b is engaged with the third gear 104c so as to transmit the rotational force, and the third gear 104c is engaged with the fourth gear 104d so as to transmit the rotational force generated from the motor 102 of the driving unit 110 to the shaft S of the icemaker coupled to the fourth gear 104d.

At this time, as illustrated in FIGS. 4 and 5, the first gear 104a engaged with the motor 102 has the magnet M provided thereon. The magnet M may sense a signal generated by the rotation of the gear unit 104 through a magnetic force in interconnection with the hall IC of the driving unit 110, and output the sensed signal. Thus, the icemaker may be driven according to the amount of ice in the icemaker.

As described above, the driving device of the icemaker for refrigerator according to the embodiment of the present invention includes the case and the driving unit. The driving unit is mounted in the case, includes the hall IC, the gear unit having the magnet interconnected with the hall IC, and the motor connected to the gear unit, and drives the icemaker of the refrigerator. Since the driving device of the icemaker is assembled as one module, the assembly time and speed may be improved to increase workability. Simultaneously, a low-voltage DC motor may be used to reduce the risk of fire of electric shock, thereby increasing stability. Furthermore, since the magnet is rotated around the center axis of the gear unit, a rotation signal may be sensed through a constant magnetic force and then outputted. Thus, the merchantable quality of the driving device may be maximized.

While the present invention has been described with respect to the specific embodiments, it will be apparent to those skilled in the art that various changes and modifications may be made without departing from the spirit and scope of the invention as defined in the following claims.

What is claimed is:

1. A driving device of an icemaker for refrigerator, comprising:
a case;
a driving unit mounted in the case, comprising a gear unit having a magnet formed thereon and a motor connected to the gear unit, and configured to drive an icemaker of a refrigerator; and
a housing into which the case including the driving unit is detachably inserted.

2. The driving device of claim 1, wherein the driving unit comprises a hall IC, and the hall IC is interconnected with the gear unit.

3. The driving device of claim 1, wherein the motor comprises a DC step motor.

4. The driving device of claim 1, wherein the gear unit comprises:
a first gear engaged with a rotating shaft of the motor;
a second gear engaged with the first gear;
a third gear engaged with the second gear; and
a fourth gear engaged with the third gear and positioned on the bottom surface of the case so as to transmit a rotational force of the motor to a shaft of the icemaker.

5. The driving device of claim 4, wherein the magnet is mounted on the first gear, and senses and outputs a signal generated through rotation of the gear unit in interconnection with the hall IC of the driving unit.

6. The driving device of claim 5, wherein the magnet mounted on the first gear and a receiving surface of the hall IC are provided to face each other in a state where the magnet and the receiving surface of the hall IC are separated at a predetermined interval from each other, and the magnet transmits a constant magnetic field signal, generated while the magnet is rotated around the rotating shaft of the first gear, to the hall IC.
